(19) United States
(12) Patent Application Publication
(10) Pub. No.: US 2011/0141963 A1
(43) Pub. Date: Jun. 16, 2011

(54) METHOD FOR SUPPORTING BROADCAST SERVICES IN MULTICAST BROADCAST SERVICE FREQUENCY NETWORK

(75) Inventor: Sun-Hwa LIM, Daejeon (KR)

(73) Assignee: Electronics and Telecommunications Research Institute, Daejeon (KR)

(21) Appl. No.: 12/946,249

(22) Filed: Nov. 15, 2010

(30) Foreign Application Priority Data
Dec. 16, 2009 (KR) 10-2009-0125584
Apr. 19, 2010 (KR) 10-2010-0036127

(51) Int. Cl. H04H 20/71

(52) U.S. Cl. 370/312

(57) ABSTRACT

Provided is a broadcasting service providing method. In the MBSFN, initiation for communication may be performed based on a system information message, a session between a network device and a mobile terminal may be established based on a system information block, a session start request message, a session start response message, a session notification message, and a session information message composed of parameters included in the system information message, and the session with the mobile terminal may be terminated based on a session stop request message, a session transmission response message, a session notification message, and a session information message.

### CROSS-REFERENCE TO RELATED APPLICATION(S)

This application claims the benefit of Korean Patent Application Nos. 10-2009-0125584 and 10-2010-0036127, respectively filed on Dec. 16, 2009 and Apr. 19, 2010, in the Korean Intellectual Property Office, the disclosures of which are incorporated herein by reference.

### BACKGROUND

1. Field of the Invention

The present invention relates to a broadcasting service providing method, and more particularly, to a broadcasting service providing method in a Multicast Broadcast Single Frequency Network (MBSFN).

2. Description of the Related Art

A multicast and broadcasting service may be a point-to-multi-point service where a single network device transmits data in a multi-media transmission format to multiple mobile terminals. The network device may transmit the same data to the multiple mobile terminals using a common wireless channel, to effectively use a radio resource.

For example, the data in the multi-media transmission format may be a real-time image, a voice, a still image, a text, and the like.

Specifically, a mobile communication system may provide the multicast and broadcasting service in a single-cell or multi-cell environment. In the single-cell environment, a single network device located in a single cell may multicast broadcasting data to multiple terminal devices to provide a broadcasting service.

In the multi-cell environment, each of multiple network devices located in multiple cells may multicast the broadcasting data to a corresponding terminal device among multiple terminal devices to provide the broadcasting service. In this example, the synchronization among the multiple network devices may be set, and the broadcasting data may be provided to each of the terminal devices.

Recently, standardization with respect to a Multicast Broadcast Single Frequency Network (MBSFN) has been completed and provides the multicast and broadcasting service in a long term evolution (LTE) mobile communication network. In a 3rd Generation Partnership Project (3GPP) standard, a function and a protocol of each system performing communication in the MBSFN, and the like, are merely standardized, messages between mobile terminals and network devices performing the communication in the MBSFN are not defined.

Therefore, there is a desire for a technology of providing broadcasting data in the MBSFN.

### SUMMARY

An aspect of the present invention provides parameters and messages transmitted between network devices and mobile terminals in a Multicast Broadcast Single Frequency Network (MBSFN) and thus, may provide a broadcasting service providing method that may stably provide a multicast and a broadcasting service even when a broadcasting service provider or a mobile terminal provider are different.

According to an aspect of the present invention, there is provided a broadcasting service providing method, the method including receiving a system information message used for initiating communication with a mobile terminal, transmitting a system information block being composed of parameters included in the system information message, receiving a session start request message used for establishing a session with the mobile terminal, transmitting a session start response message in response to the received session start request message, transmitting a session notification message to report a start of the broadcasting service to the mobile terminal, establishing a session with the mobile terminal by transmitting a session information message being composed of parameters included in the session start request message, receiving a session stop request message used for terminating the session with the mobile terminal, transmitting a session stop response message in response to the received session stop request message, transmitting another session notification message to report a stop of the broadcasting service to the mobile terminal, and terminating the session with the mobile terminal by transmitting another session information message being composed of parameters included in the session stop request message.

The system information message, the session start request message, the session stop request message, the session start response message, the session stop response message, the session notification message, the other session notification message, the session information message, and the other session information message may be used in an MBSFN.

The system information message may include a multicast channel subframe allocation pattern (MSAP) parameter, an MSAP period parameter, an MSAP start time parameter, a cyclic prefix type parameter, and a modulation and coding scheme (MCS) parameter.

Each of the session start request message and the session stop request message may include the MSAP parameter, the MSAP period parameter, and a session information list.

When a session corresponding to the session start request message is a new session, the session information list included in the session start request message may include a session identifier parameter, a session action parameter, a session priority parameter, a session Quality of Service (QoS) parameter, a radio bearer identifier parameter, and a logical channel identifier parameter.

When a session corresponding to the session start request message is an existing session, the session information list included in the session start request message may include a session identifier parameter and a session priority parameter.

According to an aspect of the present invention, there is provided a broadcasting service receiving method, the method including initiating communication with a mobile terminal by receiving a system information block, receiving a session notification message reporting a start of the broadcasting service, establishing a session with a network device by receiving a session information message being composed of parameters included in the session start request message, receiving broadcasting data from the network device when the session is established, receiving another session notification message reporting a stop of the broadcasting service, and terminating the session with the network device by receiving another session information message being composed of parameters included in the session stop request message.

The system information block, the session notification message, the other session notification message, the session information message, and the other session information message may be used in an MBSFN.

The broadcasting data may be MBMS data.

According to an aspect of the present invention, there is provided a broadcasting system providing method, the method including transmitting a system information message to a network device, transmitting, to the network device, a session start request message being composed based on parameters included in the system information message, establishing a session with the network device by receiving a session start response message in response to the transmitted session start request message, transmitting broadcasting data when the session is established, transmitting, to the network device, a session stop request message used for terminating the session, and terminating the session with the network device by receiving a session stop response message in response to the transmitted session stop request message.

The transmitting of the session start request message may include comparing an existing MSAP parameter and an existing MSAP period parameter included in the system information message with an MSAP parameter and an MSAP period parameter obtained using a radio resource allocation algorithm, respectively, transmitting the session start request message being composed of the obtained MSAP parameter and the MSAP period parameter when the existing MSAP parameter and the existing MSAP period parameter are different from the obtained MSAP parameter and the obtained MSAP period parameter, and transmitting the session start request message being composed of the existing MSAP parameter and the existing MSAP period parameter when the existing MSAP parameter and the existing MSAP period parameter are the same as the obtained MSAP parameter and the obtained MSAP period parameter.

The system information message, the session start request message, the session stop request message, the session start response message, and the session stop response message may be used in the MBSFN.

Additional aspects, features, and/or advantages of the invention will be set forth in part in the description which follows and, in part, will be apparent from the description, or may be learned by practice of the invention.

### Effect

According to embodiments, an interface used for providing a broadcasting service in a Multicast Broadcast Single Frequency Network (MBSFN) that is not yet standardized is defined and a controlling method thereof is provided and thus, a broadcasting service may be provided in a 3rd Generation Partnership Project (3GPP)-based multi-cell environment.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a communication system including multiple cells and multiple mobile terminals;

FIGS. 2 through 12 are diagrams illustrating configurations of messages used for initiation for communication, and establishing and releasing a session in a Multicast Broadcast Single Frequency Network (MBSFN);

FIG. 13 is a flowchart illustrating an initiation method for communication to provide a broadcasting service in an MBSFN;

FIG. 14 is a flowchart illustrating a broadcasting service providing method in an MBSFN; and

FIG. 15 is a flowchart illustrating a broadcasting service terminating method in an MBSFN.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

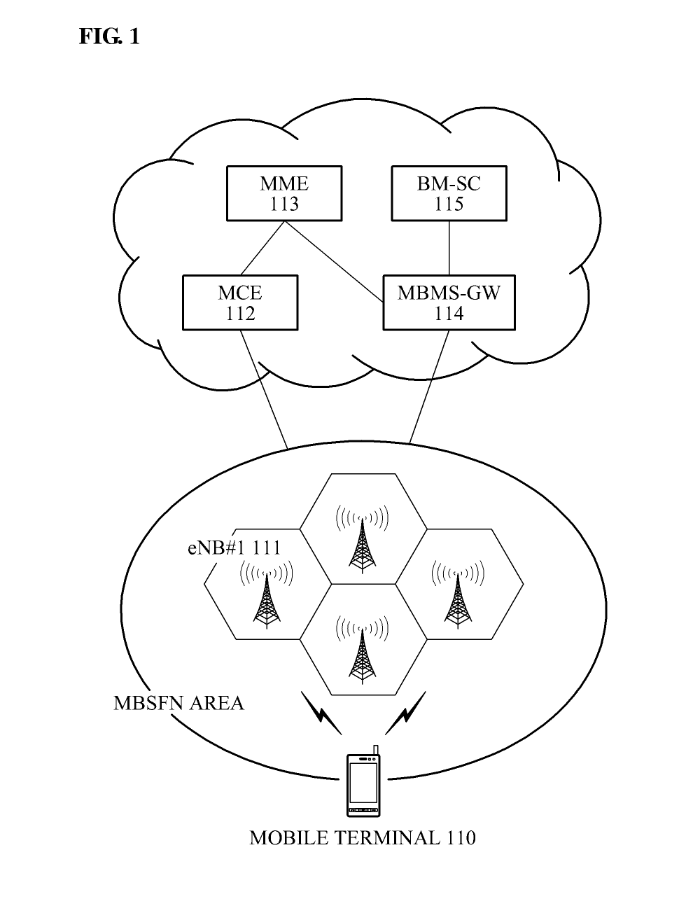

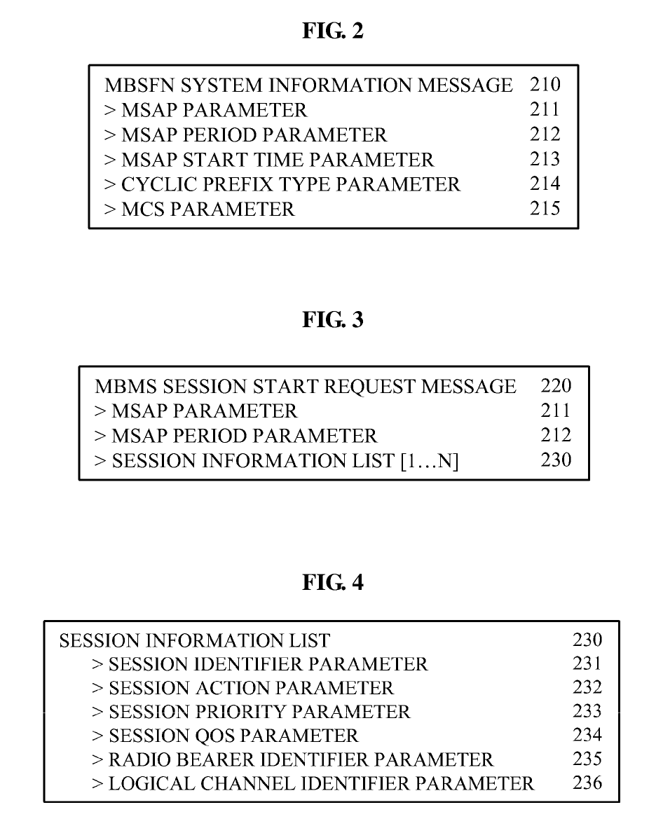

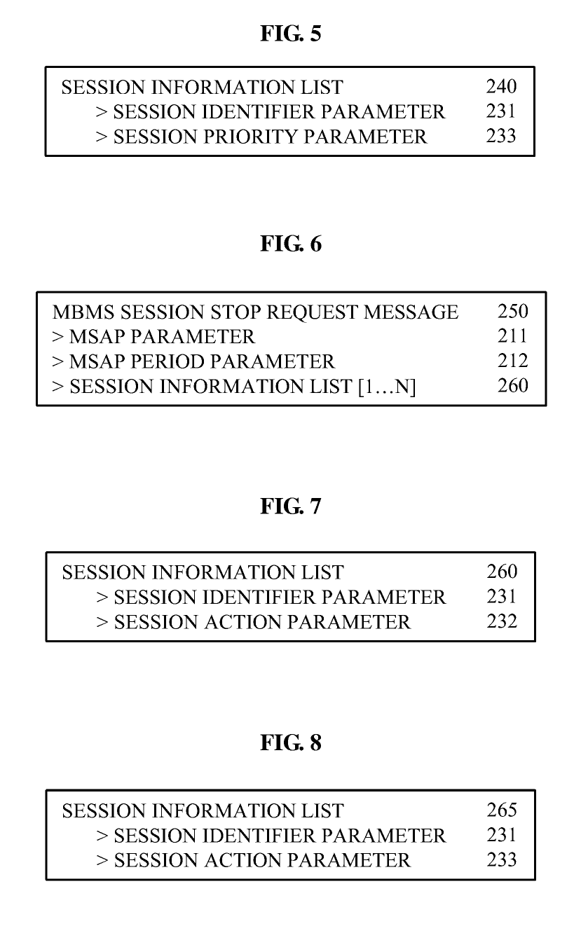

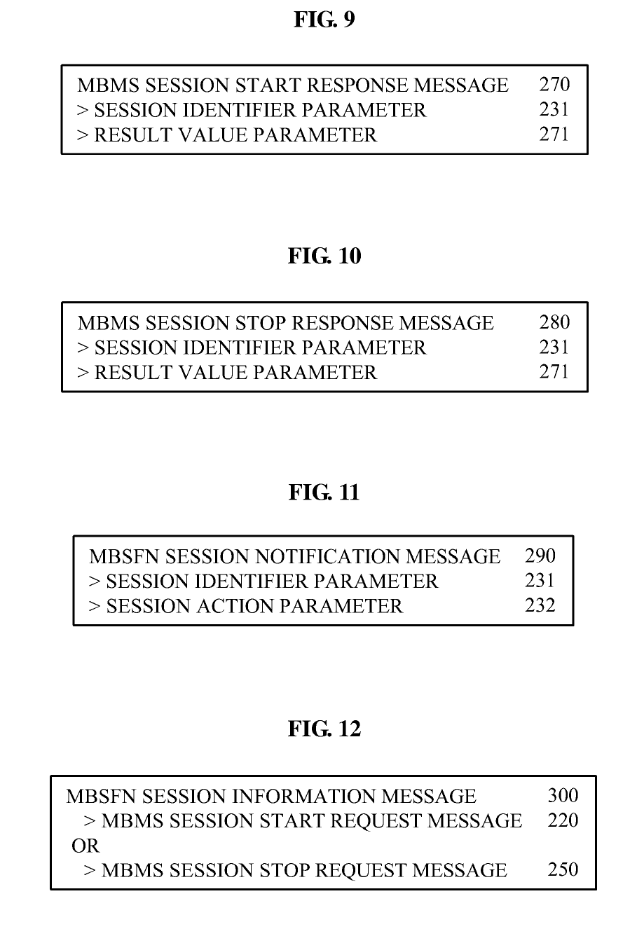

FIG. 1 illustrates a communication system including multiple cells and multiple mobile terminals.

Referring to FIG. 1, the communication system includes multiple network devices corresponding to multiple cells and a mobile terminal 110. In this example, an Evolved NodeB (eNB) may be used as a network device 111.

The mobile terminal 110 may receive synchronized broadcasting data via a multicast channel from the multiple network devices. The broadcasting data may be in packet format.

The mobile terminal 110 may perform receiving of the broadcasting data or may terminate the receiving of the broadcasting data, based on radio resource control information received from the network devices.

The multiple network devices may synchronize the broadcasting data and may transmit the synchronized broadcasting data. The multiple network devices may be located in a Multicast Broadcast Service Frequency Network (MBSFN) area.

For example, the multiple network devices may be synchronized with each other to provide, at the same time, the broadcasting data to the mobile terminal 110. In this example, the synchronization among the multiple network devices may be performed based on synchronization information received from a gateway 114.

For example, the synchronization information may include a time stamp, and a Multimedia Broadcast and Multicast Service-Gateway (MBMS-GW) may be used as the gateway 114.

The multiple network devices may receive broadcasting data from the gateway 114 and may transmit the received broadcasting data to the mobile terminal 110. For example Multimedia Broadcast and Multicast Service (MBMS) data may be used for the broadcasting data.

In this example, radio resource information, radio resource configuration information, and the like used in the multiple network devices may be allocated from a multi-cell/multicast coordination entity (MCE) 112. For example, the radio resource information may include a sub-frame used for transmission in the multiple cells, and the radio resource configuration information may include a modulation and coding scheme (MCS).

The mobile management entity (MME) 113 may transmit, to the MCE 112, session control messages used for establishing or terminating a session between the MCE 112 and each of the multiple network devices and a session between each of the multiple network devices and the mobile terminal 110.

A Broadcast and Multicast-Service Center (BM-SC) 115 may transmit, to the gateway 114, the session control messages, the synchronization information, and the broadcasting data.

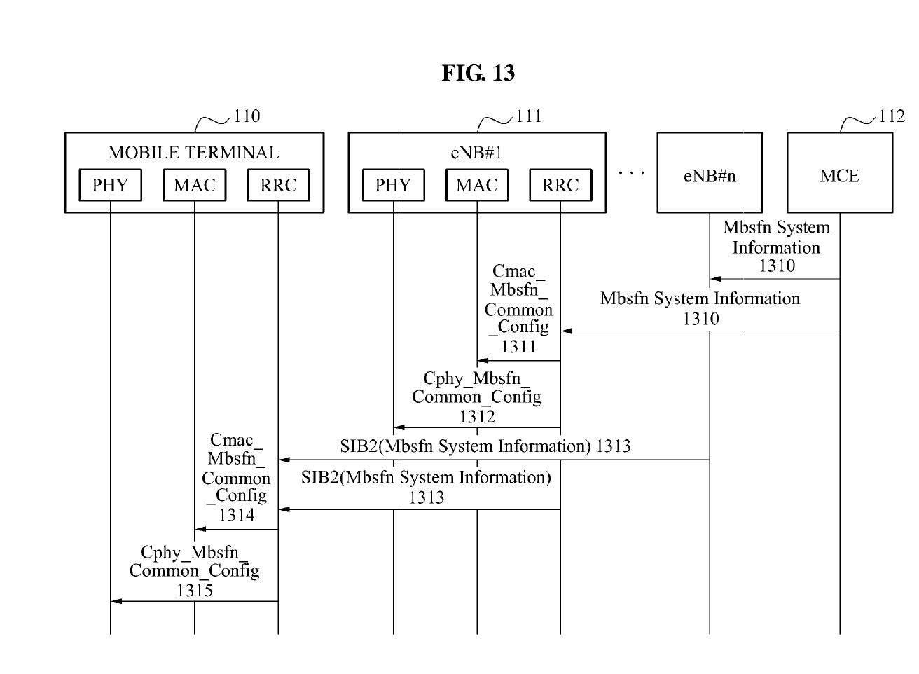

FIG. 13 illustrates an initiation method for communication to provide a broadcasting service in an MBSFN. For ease of description, a network device may be referred to as an eNB.

Referring to FIG. 13, the MCE 112 transmits, to eNB #1 111, a system information message (MBSFN SYSTEM INFORMATION) 210 in operation 1310. Here, an eNB, for example the eNB #1 111, may be located in each of multiple cells in the MBSFN as illustrated in FIG. 1. The MCE 112 may transmit the MBSFN SYSTEM INFORMATION 210 to multiple eNBs. The eNB #1 111 may set initiation based on the MBSFN SYSTEM INFORMATION 210.

The MBSFN SYSTEM INFORMATION 210 may include initiation parameters for providing a broadcasting service in the eNB #1 111. For example, the MBSFN SYSTEM INFORMATION 210 may include a multicast channel subframe allocation pattern (MSAP) parameter 211, an MSAP period parameter 212, an MSAP start time parameter 213, a Cyclic Prefix Type parameter 214, and an MCS 215.

For example, a Radio Resource Controller (RRC) of the eNB #1 111 may receive the MBSFN SYSTEM INFORMATION 210 received from the MCE 112. The RRC of the eNB #1 111 may generate a Media Access Control (MAC) common message (CMAC_MBSFN_COMMON_CONFIG) being composed of multiple parameters included in the MBSFN SYSTEM INFORMATION 210 and may transmit the generated CMAC_MBSFN_COMMON_CONFIG to a MAC layer in operation 1311.

In this example, the CMAC_MBSFN_COMMON_CONFIG and a physical (PHY) common message (CPHY_MBSFN_COMMON_CONFIG) may be used for setting initial values for multi-cell transmission in a MAC layer and a PHY layer of the eNB #1 111. The CMAC_MBSFN_COMMON_CONFIG may include the MSAP parameter 211, the MSAP period parameter 212, the MSAP start time parameter 213, cyclic prefix type parameter 214, and MCS parameter 215.

The MSAP parameter 211 may include a subframe used in the MBSFN, and the MSAP period parameter 212 may include a repetition period of a broadcasting service allocated to the MSAP parameter.

The MSAP start time parameter 213 may be a parameter used for scheduling to enable multiple eNBs to provide a broadcasting service at the same system frame number (SFN).

When the cyclic prefix type parameter 214 is a subframe used in the MBSFN, the cyclic prefix parameter 214 may be used for applying an extended cyclic prefix in the PHY layer of the eNB #1 111.

The MCS parameter 214 may include a modulation result value and an encoding result value used in a multicast channel (MCH)

The RRC of the eNB 111 may generate CPHY_MBSFN_COMMON_CONFIG, being composed of the multiple parameters included in the MBSFN SYSTEM INFORMATION 210, and may transmit the generated CPHY_MBSFN_COMMON_CONFIG to the PHY layer in operation 1312. The CPHY_MBSFN_COMMON_CONFIG may include radio resource configuration information. For example, the radio resource configuration information may include the MSAP parameter 211, the cyclic prefix type parameter 214, and the MCS parameter 215.

The eNB #1 111 may generate a system information block (system information block2: SIB2) being composed of multiple parameters included in the MBSFN SYSTEM INFORMATION 210 and may transmit the generated SIB2 to the mobile terminal 110 in operation 1311.

In this example, the parameters included in the SIB2 may be the same as the parameters included in the MBSFN SYSTEM INFORMATION 210. The SIB2 may include the radio resource configuration information, such as the MSAP parameter 211, the cyclic prefix type parameter 214, and the MCS parameter 215, and may include MSAP period parameter 212 and the MSAP start time parameter 213.

The mobile terminal 110 receives the SIB2 from the eNB #1 111 in operation 1313.

An RRC of the mobile terminal 110 may use the SIB2 in the same manner the RRC of the eNB #1 111 uses the SIB2. The RRC of the mobile terminal 110 generates CMAC_MB SFN_COMMON_CONFIG and transmits the generated CMAC_MBSFN_COMMON_CONFIG to a MAC layer of the mobile terminal 110 in operation 1314. The RRC of the mobile terminal 110 generates a CPHY_MBSFN_COMMON_CONFIG and transmits the generated CPHY_MBSFN_COMMON_CONFIG to a PHY layer of the mobile terminal 110 in operation 1315.

In this example, the CMAC_MBSFN_COMMON_CONFIG and the CPHY_MBSFN_COMMON_CONFIG may be used for setting initial values for multi-cell transmission in the MAC layer and the PHY layer of the mobile terminal 110. The eNB #1 111 and the mobile terminal 110 may use the multiple parameters included in the MBSFN SYSTEM INFORMATION 210 and the SIB2 to set initiation for providing the broadcasting service in the MBSFN.

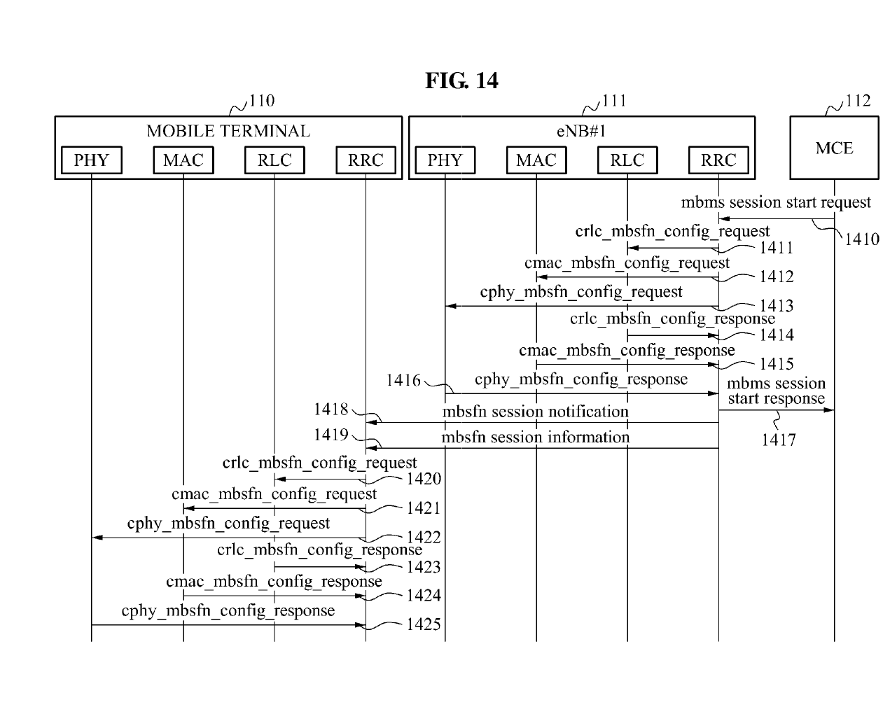

FIG. 14 illustrates a broadcasting service providing method in an MBSFN.

First, the MCE 112 may receive, from the MME 113, a session start request message (MBMS SESSION START REQUEST).

For example, the MBMS SESSION START REQUEST received from an MME 113 may include an IP multicast address parameter and a session attribute parameter. In this example, a Quality of Service (QoS) may be used as the session attribute parameter.

The MCE 112 may generate control information to control a Radio Link Controller (RLC) layer, an MAC layer, and a PHY layer of the eNB #1 111 and an RLC layer, an MAC layer, and a PHY layer of the mobile terminal 110, based on the received MBMS SESSION START REQUEST and a radio resource allocation algorithm.

For example, the MCE 112 may generate the control information based on session information included in the received MBMS SESSION START REQUEST. In this example, QoS may be used as the session information.

Referring to FIG. 3, the generated control information may include the MSAP parameter 211, the MSAP period parameter 212, and a session information list 230.

For example, when a current session is a new session, the session information list 230 may include a session identifier parameter 231, a session action parameter 232, a session priority parameter 233, a session QoS parameter 234, a radio bearer identifier parameter 235, and a local channel identifier parameter 236, as illustrated in FIG. 4.

When the current session is an existing session, the session information list 240 may include the session identifier parameter 231 and the session priority parameter 233.

The session identifier parameter 231 may be an identifier used for distinguishing between multiple sessions. For example, when three broadcasting services, such as CNN NEWS, ABC SPORTS, and NHN NEWS, are provided, a session identifier parameter, such as a channel number and the like, may be used for distinguishing between sessions where three broadcasting services are provided.

The session action parameter 232 may be a parameter indicating a state of a current session where a broadcasting service is being provided. For example, when the current session is being established or when the broadcasting service is being provided after the session is established, the session action parameter 232 may be set to be activated. Conversely, when the current session is terminated, the session action parameter 232 may be set to be deactivated.

The session priority parameter 233 may be a parameter indicating priorities among multiple sessions being currently connected.

The session QoS parameter 234 may be a parameter indicating QoS information of a session included in the system information 210 received from the MME 113.

The radio bearer identifier parameter 235 and a logical channel identifier parameter 236 may be parameters used for buffering broadcasting data and for setting a Multicast Traffic Channel (MTCH).

Specifically, the MCE 112 may compare an existing MSAP parameter included in the MBSFN SYSTEM INFORMATION 210 with an MSAP parameter obtained using the radio resource allocation algorithm, and may compare an existing MSAP period parameter included in the MBSFN SYSTEM INFORMATION 210 with an MSAP period parameter obtained using the radio resource allocation algorithm.

When the existing MSAP parameter and the obtained MSAP parameter are different, the MCE 112 may update the existing MSAP parameter included in the MBMS SESSION START REQUEST 220 with the obtained MSAP parameter. In the same manner, when the existing MSAP period parameter and the obtained MSAP period parameter are different, the MCE 112 may update the existing MSAP period parameter included in the MBMS SESSION START REQUEST 220 with the obtained MSAP period parameter.

When the existing MSAP parameter and the obtained MASP parameter are the same, the MCE 112 may maintain the existing MSAP parameter included in the MBMS SESSION START REQUEST 220, and when the existing MSAP period parameter and the obtained MSAP period parameter are the same, the MCE 112 may maintain the existing MSAP period parameter included in the MBMS SESSION START REQUEST 220.

Subsequently, the MCE 112 may transmit, to the eNB #1 111, MBMS SESSION START REQUEST 220 in operation 1410. The MBMS SESSION START REQUEST 220 may include the existing or updated MSAP parameter and the existing or updated MSAP period parameter.

In this example, when the MBMS SESSION START REQUEST 220 is received, the RRC of the eNB #1 111 may generate an RLC request message (CRLC_MBSFN_CONFIG_REQUEST), a MAC request message (CMAC_MBSFN_CONFIG_REQUEST), and a PHY request message (CPHY_MBSFN_CONFIG_REQUEST), based on parameters included in the MBSFN SYSTEM INFORMATION 210 and the MBMS SESSION START REQUEST 220.

The RRC of the eNB #1 111 transmits the generated CRLC_MBSFN_CONFIG_REQUEST to an RLC layer in operation 1411, transmits the generated CMAC_MBSFN_CONFIG_REQUEST to an MAC layer in operation 1412, and transmits the generated CPHY_MBSFN_CONFIG_REQUEST to a PHY layer in operation 1413.

The CRLC_MBSFN_CONFIG_REQUEST may include the radio bearer identifier parameter 235, the MTCH identifier parameter 236, the MSAP period parameter 212, and the like. The radio bearer identifier parameter 235, the MTCH identifier parameter 236, and the MSAP period parameter 212 may be used for buffering the broadcasting data and for setting the MTCH.

The CMAC_MBSFN_CONFIG_REQUEST may include the MSAP parameter 211, the MSAP period parameter 212, and the session information list 230. The MSAP parameter 211, the MSAP period parameter 212, and the session information list 230 may be used for allocating a multi-radio resource used for multi-cell transmission.

The CPHY_MBSFN_CONFIG_REQUEST may include the MSAP parameter 211, the cyclic prefix type parameter 213, and the MCS parameter 215. The MSAP parameter 211, the cyclic prefix type parameter 213, and the MCS parameter 215 may be used for transmitting the broadcasting data to the mobile terminal 110.

Subsequently, the RLC layer of the eNB #1 111 transmits, to the RRC of the eNB #1 111, CRLC_MBSFN_CONFIG_RESPONSE in response to the CRLC_MBSFN_CONFIG_REQUEST in operation 1414. The MAC layer of the eNB #1 111 transmits, to the RRC of the eNB #1 111, CMAC_MBSFN_CONFIG_RESPONSE, in response to the CMAC_MBSFN_CONFIG_REQUEST in operation 1415. The PHY layer of the eNB #1 111 transmits, to the RRC of the eNB #1 111, CPHY_MBSFN_CONFIG_RESPONSE in response to the CPHY_MBSFN_CONFIG_REQUEST in operation 1416.

Subsequently, the RRC of the eNB #1 111 transmits, to the MCE 112, a session start response message (MBMS SESSION START RESPONSE) 270 in response to the MBMS SESSION START REQUEST in operation 1417.

The MBMS SESSION START RESPONSE 270 may include a session identifier parameter 231 and a result value parameter 271. For example, the session identifier parameter 231 may be an identifier indicating a session start based on the MBMS SESSION START REQUEST 220 received in operation 1410. The result value parameter may be a response value with respect to the MBMS SESSION START REQUEST 220 received in operation 1410, and may include a session termination success value or a session termination failure value.

The eNB #1 111 transmit, to the mobile terminal 110, a session notification message (MBSFN SESSION NOTIFICATION) 290 in operation 1418.

The MBSFN SESSION NOTIFICATION 290 may be used for reporting that a session to be newly started or a session to be terminated exists to the mobile terminal 110, before a session start message or a session stop message is transmitted to the mobile terminal 110. For example, the MBSFN SESSION NOTIFICATION 290 may include the session identifier parameter 231 and the session action parameter 232, as illustrated in FIG. 11.

When the MBSFN SESSION NOTIFICATION is used for the session start, the eNB #1 111 may set the session action parameter 232 to be activated, and may transmit, to the mobile terminal 110, the MBSFN SESSION NOTIFICATION 290 including the session action parameter 232 set to be activation.

When the MBSFN SESSION NOTIFICATION 290 is transmitted, the eNB #1 111 may transmit, to the mobile terminal 110, a session information message (MBSFN SESSION INFORMATION) 300 in operation 1419.

For example, the MBSFN SESSION INFORMATION 300 may include the MBMS SESSION START REQUEST 220 or a session stop request message (MBMS SESSION STOP REQUEST) 250, as illustrated in FIG. 12.

When a connection of a session between the eNB #1 111 and the mobile terminal 110 is established, the MBSFN SESSION INFORMATION 300 may be composed of parameters, namely, the MSAP parameter 211, the MSAP period parameter 212, and the session information list 230, included in the MBMS SESSION START REQUEST 220.

The eNB #1 111 may transmit the broadcast data to the mobile terminal 110 after transmitting the MBSFN SESSION INFORMATION 300. For example, MBMS data may be used as the broadcasting data.

When the MBSFN SESSION NOTIFICATION 290 and the MBSFN SESSION INFORMATION 300 are received, the RRC of the mobile terminal 110 may generate CRLC_MBSFN_CONFIG_REQUEST, CMAC_MBSFN_CONFIG_REQUEST, and CPHY_MBSFN_CONFIG_REQUEST based on the parameters included in the MBSFN SESSION INFORMATION 300 and the SIB2.

The RRC of the mobile terminal 110 may transmit the generated CRLC_MBSFN_CONFIG_REQUEST to the RLC layer of the mobile terminal 110 in operation 1420. The RRC of the mobile terminal 110 may transmit the generated CMAC_MBSFN_CONFIG_REQUEST to the MAC layer of the mobile terminal 110 in operation 1421. The RRC of the mobile terminal 110 may transmit the generated CPHY_MBSFN_CONFIG_REQUEST to the PHY layer of the mobile terminal 110 in operation 1422.

For example, the mobile terminal 110 may extract a session identifier parameter and a session action parameter included in a session information list of the received MBSFN SESSION INFORMATION 300.

When the extracted session action parameter is in an active state, each of the RLC layer, the MAC layer, and the PHY layer may set a radio bearer parameter, an MTCH, and changed radio resource configuration information, based on a corresponding request message, such as the CRLC_MBSFN_CONFIG_REQUEST, the CMAC_MBSFN_CONFIG_REQUEST, and the CPHY_MBSFN_CONFIG_REQUEST and thus, broadcasting data corresponding to the extracted session identifier parameter may be received from the eNB #1 111.

The CRLC_MBSFN_CONFIG_REQUEST, the CMAC_MBSFN_CONFIG_REQUEST, and the CPHY_MBSFN_CONFIG_REQUEST are basically the same as the CRLC_MBSFN_CONFIG_REQUEST, the CMAC_MBSFN_CONFIG_REQUEST, and the CPHY_MBSFN_CONFIG_REQUEST respectively generated in operations 1411, 1412, and 1413 and thus, detailed descriptions thereof will be omitted.

The RLC layer of the mobile terminal 110 transmits, to the RRC of the mobile terminal, CRLC_MBSFN_CONFIG_RESPONSE in response to the CRLC_MBSFN_CONFIG_REQUEST 110 in operation 1423. The MAC layer of the mobile terminal 110 transmits, to the RRC of the mobile terminal 110, CMAC_MBSFN_CONFIG_RESPONSE in response to the CMAC_MBSFN_CONFIG_REQUEST in operation 1424. The PHY layer of the mobile terminal 110 transmits, to the RRC of the mobile terminal 110, CPHY_MBSFN_CONFIG_RESPONSE in response to the CPHY_MBSFN_CONFIG_REQUEST in operation 1424.

The RLC response message, the MAC response message, and the PHY response message are basically the same as the RLC response message, the MAC response message, and the PHY response respectively generated in operations 1414, 1415, 1416 and thus, detailed descriptions thereof will be omitted.

When the RRC of the mobile terminal 110 receives the RLC response message, the MAC response message, and the PHY response message, a session between the mobile terminal 110 and the eNB #1 111 may be established. Specifically, establishing of the session for providing a new broadcasting service to the mobile terminal 110 may be completed.

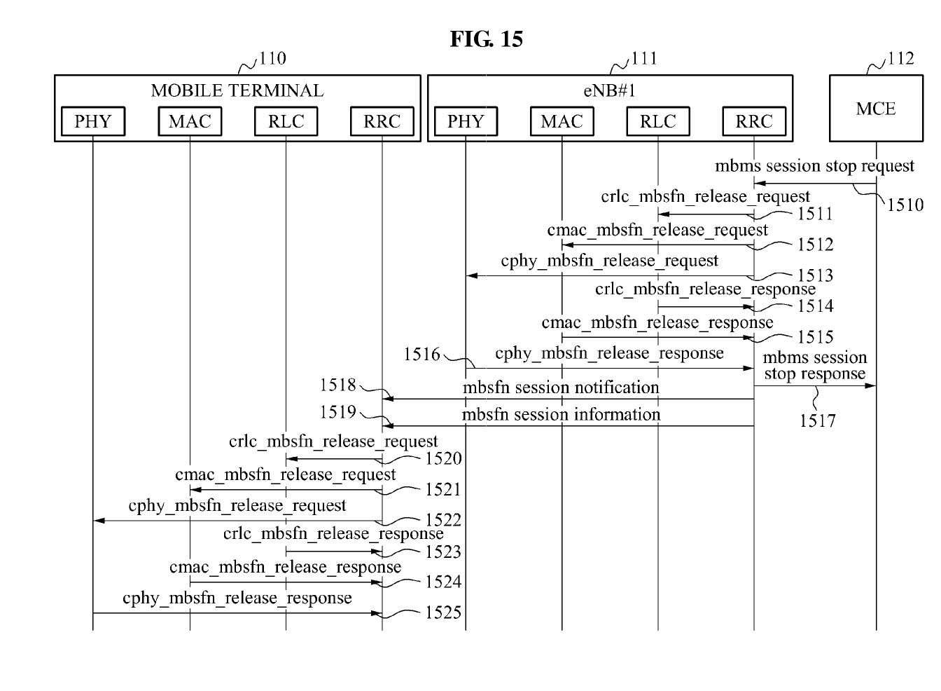

FIG. 15 illustrates a broadcasting service termination method in an MBSFN.

First, the MCE 112 may receive, from an MME 113, MBMS SESSION STOP REQUEST.

The MCE 112 may generate control information to control an RLC layer, an MAC layer, and a PHY layer of each of the eNB #1 111 and the mobile terminal 110 based on the received MBMS SESSION STOP REQUEST 250, MBSFN SYSTEM INFORMATION 210, and a radio resource allocation algorithm.

For example, the generated control information may include an MSAP parameter 211, the MSAP period parameter 212, and the session information list 230. The MBMS SESSION STOP REQUEST 250 may include the MSAP parameter 211, the MSAP period parameter 212, and the session information list 260.

In this example, when a session is terminated based on the MBMS SESSION STOP REQUEST 250, the session information list 260 may include the session identifier 231 and the session action parameter 232 as illustrated in FIG. 7.

The MCE 112 may generate the control information used for terminating the session, based on session information associated with existing sessions excluding the session to be terminated and the radio resource allocation algorithm. For example, a QoS may be used as the session information, and the session to be terminated may be determined by the session identifier parameter 231.

In this example, the session information list 265 associated with the existing sessions may include the session identifier parameter 231 and a session priority parameter 233. The session priority parameter 233 may be a parameter indicating priorities among changed existing sessions due to the terminated session.

Specifically, the MCE 112 may compare an existing MSAP parameter included in the MBSFN SYSTEM INFORMATION 210 with an MSAP parameter obtained based on the radio resource allocation algorithm, and may compare an existing MSAP period parameter included in the MBSFN SYSTEM INFORMATION 210 with an MSAP period parameter obtained based on the radio resource allocation algorithm.

When the existing MSAP parameter and the obtained MSAP parameter are different, the MCE 112 may update the existing MSAP parameter included in the MBMS SESSION STOP REQUEST 250 with the obtained MSAP parameter. In the same manner, when the existing MSAP period parameter and the obtained MSAP period parameter are different, the MCE 112 may update the existing MSAP period parameter included in the MBMS SESSION STOP REQUEST 250 with the obtained MSAP period parameter.

Conversely, when the existing MSAP parameter and the obtained MSAP parameter are the same, the MCE 112 may maintain the existing MSAP parameter included in the MBMS SESSION STOP REQUEST 250, and when the existing MSAP period parameter and the obtained MSAP period parameter are the same, the MCE 112 may maintain the existing MSAP period parameter included in the MBMS SESSION STOP REQUEST 250.

The MCE 112 transmits, to the eNB #1 111, the MBMS SESSION STOP REQUEST 250 in operation 1510. The MBMS SESSION STOP REQUEST 250 may include the existing or updated MSAP parameter and the existing or updated MSAP period parameter.

In this example, the MCE 112 may include radio resource configuration information in the MBMS SESSION STOP REQUEST 250 and may transmit the MBMS SESSION STOP REQUEST 250 to the eNB #1 111.

For example, the radio resource configuration information may include the MSAP parameter 211, the cyclic prefix type parameter 213, and the MCE parameter 215 included in the MBSFN SYSTEM INFORMATION 210 received in operation 1310.

When the MBMS SESSION STOP REQUEST 250 is received, an RRC of the eNB #1 111 may generate an RLC stop message (CRLC_MBSFN_RELEASE_REQUEST), an MAC stop message (CMAC_MBSFN_RELEASE_REQUEST), and a PHY stop message (CPHY_MBSFN_RELEASE_REQUEST), based on parameters included in the MBSFN SYSTEM INFORMATION 210 and the MBMS SESSION STOP REQUEST 250.

The RRC of the eNB #1 111 transmits the generated CRLC_MBSFN_RELEASE_REQUEST to an RLC layer in operation 1511, transmits the generated CMAC_MBSFN_RELEASE_REQUEST to an MAC layer in operation 1512, and transmits the generated CPHY_MBSFN_RELEASE_REQUEST to a PHY layer in operation 1513.

The CRLC_MBSFN_RELEASE_REQUEST may include the radio bearer identifier parameter 235, the MTCH identifier parameter 236, and the like. The radio bearer identifier parameter 235, the MTCH identifier parameter 236, and the MSAP period parameter 212 may be used for terminating a setting of the radio bearer and for terminating a setting of an MTCH.

The CMAC_MBSFN_RELEASE_REQUEST may include the MSAP parameter 211, the MSAP period parameter 212, and the session information list 230.

The MSAP 211, the MSAP period parameter 212, the session information list 230 may be used for allocating a radio resource based on the radio resource configuration information transmitted in operation 1510. The radio resource configuration information may be changed as a broadcasting service is terminated in the MAC layer of the eNB #1 111.

The CPHY_MBSFN_RELEASE_REQUEST may include the MSAP parameter 211, the cyclic prefix type parameter 213, and the MCS parameter 215. The MSAP parameter 211, the cyclic prefix type parameter 213, and the MCS parameter 215 may be control information that may be applied to the existing session.

For example, the MSAP parameter 211, the cyclic prefix type parameter 213, and the MCS parameter 215 may be used for transmitting, to the eNB #1 111, broadcasting data currently being in service.

The RLC layer of the eNB #1 111 transmits, to the RRC of the eNB #1 111, CRLC_MBSFN_RELEASE_RESPONSE in response to the CRLC_MBSFN_RELEASE_REQUEST in operation 1514. The MAC layer of the eNB #1 111 transmits, to the RRC of the eNB #1 111, CMAC_MBSFN_RELEASE_RESPONSE in response to the CMAC_MBSFN_RELEASE_REQUEST in operation 1515. The PHY layer of the eNB #1 111 transmits, to the RRC of the eNB #1 111, CPHY_MBSFN_RELEASE_RESPONSE in response to the CPHY_MBSFN_RELEASE_REQUEST in operation 1516.

The RRC of the eNB #1 111 may transmit, to the MCE 112, a session stop response message (MBMS SESSION STOP RESPONSE) 280 in response to the MBMS SESSION STOP REQUEST 250 in operation 1517.

For example, the MBMS SESSION STOP RESPONSE 280 may include the session identifier parameter 231 and the result value parameter 271, as illustrated in FIG. 10. The session identifier parameter 231 may be an identifier indicating that the session is terminated based on the MBMS SESSION STOP REQUEST 250 received in operation 1510. The result value may be a response value with respect to the MBMS SESSION STOP REQUEST 250 received in operation 1510, and may include a session termination success value or a session termination failure value.

The eNB #1 111 transmits, to the mobile terminal 110, MBSFN SESSION NOTIFICATION 290 in operation 1518. For example, the MBSFN SESSION NOTIFICATION 290 may include parameters, namely, the session identifier parameter 231 and the session action parameter 232, as illustrated in FIG. 11.

In this example, when the MBSFN SESSION NOTIFICATION 290 is used for terminating the session, the eNB #1 111 may set the session action to be deactivated, and may transmit, to the mobile terminal 110, the MBSFN SESSION NOTIFICATION including the session action set to be deactivated.

When the MBSFN SESSION NOTIFICATION 290 is transmitted, the eNB #1 111 transmits, to the mobile terminal 110, the MBSFN SESSION INFORMATION 300 in operation 1519.

For example, the MBSFN SESSION INFORMATION 300 may include the MBMS SESSION START REQUEST 220 or the MBMS SESSION STOP REQUEST 250, as illustrated in FIG. 12.

In this example, when the session between the eNB #1 111 and the mobile terminal 110 is terminated, the MBSFN SESSION INFORMATION 300 may be composed of parameters included in the MBMS SESSION STOP REQUEST 250, namely, MSAP parameter 211, the MSAP period parameter 212, and the session information list 260.

Subsequently, when the MBSFN SESSION NOTIFICATION 290 and the MBSFN SESSION INFORMATION 300 are received, the RRC of the mobile terminal 110 may generate CRLC_MBSFN_RELEASE_REQUEST, CMAC_MBSFN_RELEASE_REQUEST, and CPHY_MBSFN_RELEASE_REQUEST, based on the parameters included in the MBSFN SESSION INFORMATION 300 and the SIB2.

The RRC of the mobile terminal 110 transmits the generated CRLC_MBSFN_RELEASE_REQUEST to the RLC layer of the mobile terminal 110 in operation 1520. The RRC of the mobile terminal 110 transmits the generated CMAC_MBSFN_RELEASE_REQUEST to the MAC layer of the mobile terminal 110 in operation 1521. The RRC of the mobile terminal 110 transmits the generated CPHY_MBSFN_RELEASE_REQUEST to the PHY layer of the mobile terminal 110 in operation 1522.

For example, the mobile terminal 110 may extract the session identifier parameter 231 and the session action parameter 232 included in the session information list 260 of the received MBSFN SESSION INFORMATION 300.

When the extracted session action is deactivated, each of the RLC layer, the MAC layer, and the PHY layer may set a radio bearer, an MTCH, and changed radio resource configuration information, based on a corresponding stop message, such as the CRLC_MBSFN_RELEASE_REQUEST, the CMAC_MBSFN_RELEASE_REQUEST, and the CPHY_MBSFN_RELEASE_REQUEST, and thus, receiving of broadcasting data corresponding to the extracted session identifier parameter may be terminated

The process of transmitting the generated CRLC_MBSFN_CONFIG_REQUEST, the CMAC_MBSFN_CONFIG_REQUEST, and the CPHY_MBSFN_CONFIG_REQUEST to the RLC layer, the MAC layer, and the PHY layer, respectively, is basically the same as a process of transmitting the CRLC_MB SFN_RELEASE_REQUEST, the CMAC_MBSFN_RELEASE_REQUEST, and the CPHY_MBSFN_RELEASE_REQUEST in operations 1511, 1512, and 1513 and thus, detailed descriptions thereof will be omitted.

The RLC layer transmits, to the RRC of the mobile terminal 110, an RLC response message (CRLC_MBSFN_RELEASE_RESPONSE) in response to the CRLC_MBSFN_RELEASE_REQUEST in operation 1523. The MAC layer transmits, to the RRC of the mobile terminal 110, a MAC response message (CMAC_MBSFN_RELEASE_RESPONSE) in response to the CMAC_MBSFN_RELEASE_REQUEST in operation 1524. The PHY layer transmits, to the RRC of the mobile terminal 110, a PHY response message (CPHY_MBSFN_RELEASE_RESPONSE) in response to the CPHY_MBSFN_RELEASE_REQUEST in operation 1524.

The generated CRLC_MBSFN_RELEASE_RESPONSE, the CMAC_MB SFN_RELEASE_RESPONSE, and the CPHY_MBSFN_RELEASE_RESPONSE may be basically the same as the CRLC_MBSFN_RELEASE_RESPONSE, the CMAC_MBSFN_RELEASE_RESPONSE, and the CPHY_MBSFN_RELEASE_RESPONSE respectively generated in operations 1514, 1515, and 1516 and thus, detailed descriptions thereof will be omitted.

When the RRC of the mobile terminal 110 receives the CRLC_MBSFN_RELEASE_RESPONSE, CMAC_MBSFN_RELEASE_RESPONSE, and the CPHY_MBSFN_RELEASE_RESPONSE, the RRC of the mobile terminal 110 may terminate the session between the mobile terminal 110 and the eNB #1 111. Therefore, the session established between the eNB #1 111 and the mobile terminal 110 may be released so as to stop providing, to the mobile terminal 110, the broadcasting service to be terminated.

Although embodiments with reference to FIGS. 13 through 15 describes that multiple eNBs provide a broadcasting service to a single mobile terminal 110, the multiple eNBs may provide broadcasting services to multiple mobile terminals.

Although embodiments describes that a session between an eNB and a mobile terminal is established to provide a broadcasting service, a broadcasting service providing method of the present invention may be used for providing a communication service in addition to a broadcasting service between the eNB and the mobile terminal.

For example, the broadcasting service providing method may be used for establishing and releasing a session between an eNB and a mobile terminal being located in an MBSFN, the session being used for transmitting audio data, voice data, text data, video data, and the like.

Although a message transmitted from the MME 113 to the MCE 112 and a message transmitted from the MCE 112 to the eNB #1 111 use the same name, namely, MBMS START REQUEST, parameters included in the message transmitted from the MME 113 to the MCE 112 and parameters included in the message transmitted from the MECE 112 to the eNB #1 111 may be different.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of providing a broadcasting service, the method comprising:
receiving a system information message used for initiating communication with a mobile terminal;
transmitting a system information block being composed of parameters included in the system information message;
receiving a session start request message used for establishing a session with the mobile terminal;
transmitting a session start response message in response to the received session start request message;
transmitting a session notification message to report a start of the broadcasting service to the mobile terminal;
establishing a session with the mobile terminal by transmitting a session information message being composed of parameters included in the session start request message;
receiving a session stop request message used for terminating the session with the mobile terminal;
transmitting a session stop response message in response to the received session stop request message;
transmitting another session notification message to report a stop of the broadcasting service to the mobile terminal; and
terminating the session with the mobile terminal by transmitting another session information message being composed of parameters included in the session stop request message.

2. The method of claim 1, wherein the system information message, the session start request message, the session stop request message, the session start response message, the session stop response message, the session notification message, the other session notification message, the session information message, and the other session information message are used in a multicast broadcast single frequency network (MBSFN).

3. The method of claim 1, wherein the system information message includes a multicast channel subframe allocation pattern (MSAP) parameter, an MSAP period parameter, an MSAP start time parameter, a cyclic prefix type parameter, and a modulation and coding scheme (MCS) parameter.

4. The method of claim 3, wherein the MSAP parameter includes a subframe used in the MBSFN, and the MSAP period parameter includes a repetition period of the broadcasting service allocated to the MSAP parameter.

5. The method of claim 3, wherein each of the session start request message and the session stop request message includes the MSAP parameter, the MSAP period parameter, and a session information list.

6. The method of claim 5, wherein, when a session corresponding to the session start request message is a new session, the session information list included in the session start request message includes a session identifier parameter, a session action parameter, a session priority parameter, a session Quality of Service (QoS) parameter, a radio bearer identifier parameter, and a logical channel identifier parameter.

7. The method of claim 5, wherein, when a session corresponding to the session start request message is an existing session, the session information list included in the session start request message includes a session identifier parameter and a session priority parameter.

8. The method of claim 3, wherein each of the session start response message and the session stop response message includes a session identifier parameter and a result value parameter.

9. The method of claim 8, wherein the session identifier included in the session notice is transmitted by:
being set to be activated when the start of the broadcasting service is reported; and
being set to be deactivated when the stop of the broadcasting service is reported.

10. The method of claim 1, further comprising:
transmitting multimedia broadcast multicast service (MBMS) data to the mobile terminal when the session with the mobile terminal is set.

11. A method of receiving a broadcasting service, the method comprising:
initiating communication with a mobile terminal by receiving a system information block;
receiving a session notification message reporting a start of the broadcasting service;
establishing a session with a network device by receiving a session information message being composed of parameters included in the session start request message;
receiving broadcasting data from the network device when the session is established;
receiving another session notification message reporting a stop of the broadcasting service; and
terminating the session with the network device by receiving another session information message being composed of parameters included in the session stop request message.

12. The method of claim 11, wherein the system information block, the session notification message, the other session notification message, the session information message, and the other session information message are be used in an MBSFN.

13. The method of claim 11, wherein the broadcasting data is MBMS data.

14. The method of claim 11, wherein a system information message includes an MSAP parameter, an MSAP period parameter, an MSAP start time parameter, a cyclic prefix type parameter, and an MCS parameter.

15. The method of claim 14, wherein the MSAP parameter includes a subframe used in the MBSFN, and the MSAP period parameter includes a repetition period of the broadcasting service allocated to the MSAP parameter.

16. The method of claim 16, wherein:
each of the session start request message and the session stop request message includes the MSAP parameter, the MSAP period parameter, and a session information list;
each of the session start response message and the session stop response message includes a session identifier parameter and a result value parameter; and
the session notification message includes the session identifier parameter and a session action parameter.

17. A method of providing a broadcasting system, the method comprising:
transmitting a system information message to a network device;
transmitting, to the network device, a session start request message being composed based on parameters included in the system information message;
establishing a session with the network device by receiving a session start response message in response to the transmitted session start request message;
transmitting broadcasting data when the session is established;
transmitting, to the network device, a session stop request message used for terminating the session; and
terminating the session with the network device by receiving a session stop response message in response to the transmitted session stop request message.

18. The method of claim 17, wherein the transmitting of the session start request message comprises:
comparing an existing MSAP parameter and an existing MSAP period parameter included in the system information message with an MSAP parameter and an MSAP period parameter obtained using a radio resource allocation algorithm, respectively;
transmitting the session start request message being composed of the obtained MSAP parameter and the MSAP period parameter when the existing MSAP parameter and the existing MSAP period parameter are different from the obtained MSAP parameter and the obtained MSAP period parameter; and
transmitting the session start request message being composed of the existing MSAP parameter and the existing MSAP period parameter when the existing MSAP parameter and the existing MSAP period parameter are the same as the obtained MSAP parameter and the obtained MSAP period parameter.

19. The method of claim 17, wherein the system information message, the session start request message, the session stop request message, the session start response message, and the session stop response message are used in the MBSFN.

20. The method of claim 17, wherein the broadcasting data is MBMS data.
